(19) United States
(12) Patent Application Publication
(10) Pub. No.: US 2009/0195513 A1
(43) Pub. Date: Aug. 6, 2009

(54) INTERACTIVE MULTIMEDIA CONTROL MODULE

(75) Inventors: Ronald H. Dybalski, Oxford, MI (US); Frederick J. Berg, Auburn, MI (US); Timothy J. Bennett, Kawkawlin, MI (US); Adam J. Pfenninger, Bay City, MI (US)

Correspondence Address: DELPHI TECHNOLOGIES, INC., M/C 480-410-202, PO BOX 5052, TROY, MI, 48007, US

(73) Assignee: Delphi Technologies, Inc., Troy, MI (US)

(21) Appl. No.: 12/026,440

(22) Filed: Feb. 5, 2008

(51) Int. Cl. G06F 3/041

(52) U.S. Cl. 345/173

(57) ABSTRACT

An interactive control module communicates with one or more portable electronic devices to control the portable electronic devices. The interactive control module includes a touch screen display that displays a virtual image of the portable electronic device. A user enters a command into the touch screen display by touching a virtual control feature corresponding to an actual control feature of the portable electronic device. The interactive control module then executes the command by either transmitting the command to the portable electronic device or by executing files downloaded from the portable electronic device.

### BACKGROUND OF THE INVENTION

1. Field of the Invention

The subject invention relates to a method of operating a portable electronic device with an interactive control module. The interactive control module being in communication with the portable electronic device and having a touch screen display.

2. Description of the Prior Art

U.S. Published Patent Application 2007/0198472 A1 to Simonds et al. discloses a vehicle having a multi-media system and a method for accessing data stored on portable electronic devices with the multi-media system. The multi-media system includes a controller and a user interface. The controller includes a processor. The user interface may include a touch screen display in communication with the controller. The controller is in communication with the portable electronic device through either a hard wired connection or by the use of a wireless communication system, such as infrared, Bluetooth, and WI-FI. The controller detects the presence of the portable electronic device, and accesses data from the portable electronic device. A menu is displayed on the touch screen display identifying the content of the information stored on the portable electronic device. A user touches the touch screen display to input a command. The controller then executes the command inputted. The multi-media system permits the use and operation of the portable electronic device through inputs entered into the touch screen display, thereby eliminating the need to handle the actual portable electronic device. However, the user must still navigate a “middle-ware” software menu displayed on the touch screen display, the use of which may not be intuitive to the user.

### SUMMARY OF THE INVENTION AND ADVANTAGES

The subject invention provides a method of operating a portable electronic device with an interactive control module. The interactive control module is in communication with the portable electronic device, and includes a touch screen display. The method comprises the steps of: detecting the presence of the portable electronic device; accessing data from the portable electronic device; displaying a virtual image of the portable electronic device on the touch screen display, wherein the virtual image includes a virtual control feature replicating a control feature on the portable electronic device; inputting a command into the touch screen display; and executing the command.

Accordingly, the virtual image of the portable electronic device provides an intuitive interface into which a user may input commands and eliminates the “middle-ware” software menu. The User instinctively knows how to operate the interactive control module because the virtual image is identical to the portable electronic device with which the user is already familiar with.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a plan view showing an interactive control module for operating a first portable electronic device integrated into an instrument panel of a vehicle and showing the first portable electronic device;

FIG. 2 is a plan view showing the interactive control module for operating a second portable electronic device integrated into the instrument panel of the vehicle and showing the second portable electronic device;

FIG. 3 is a plan view showing the interactive control module for operating a third portable electronic device integrated into the instrument panel of the vehicle and showing the third portable electronic device;

FIG. 4 is a plan view showing the interactive control module for operating a fourth portable electronic device integrated into the instrument panel of the vehicle and showing the fourth portable electronic device;

FIG. 5 is a plan view of the interactive control module showing a plurality of portable electronic devices; and

FIG. 6 is a perspective view of the interactive control module on a base.

### DETAILED DESCRIPTION OF THE INVENTION

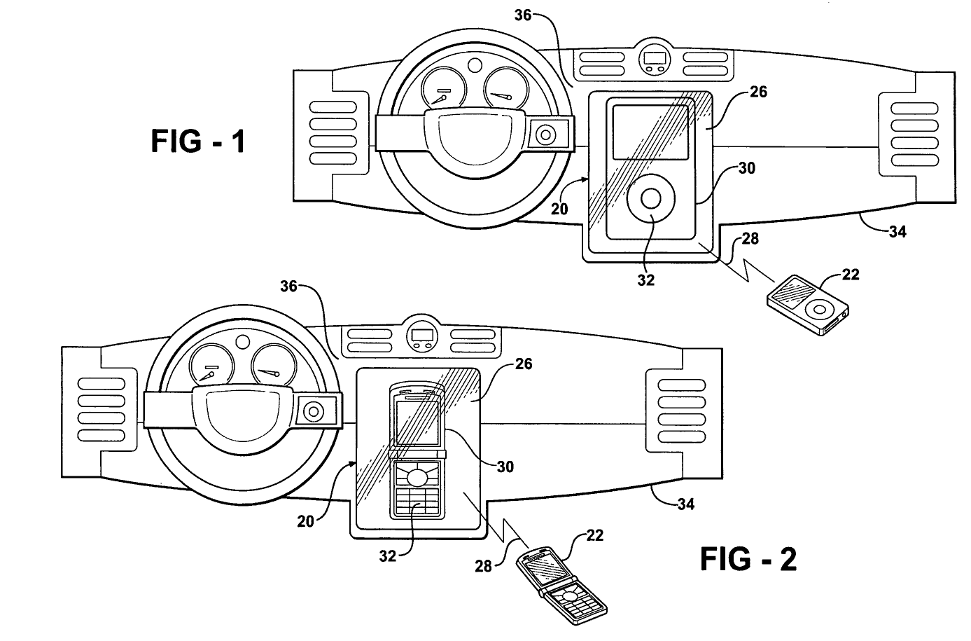

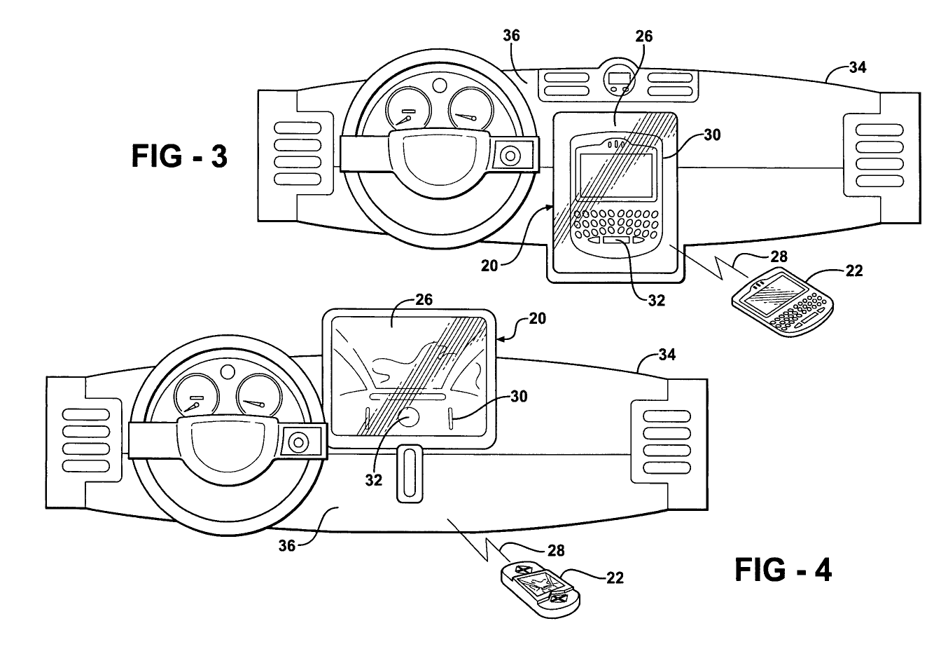

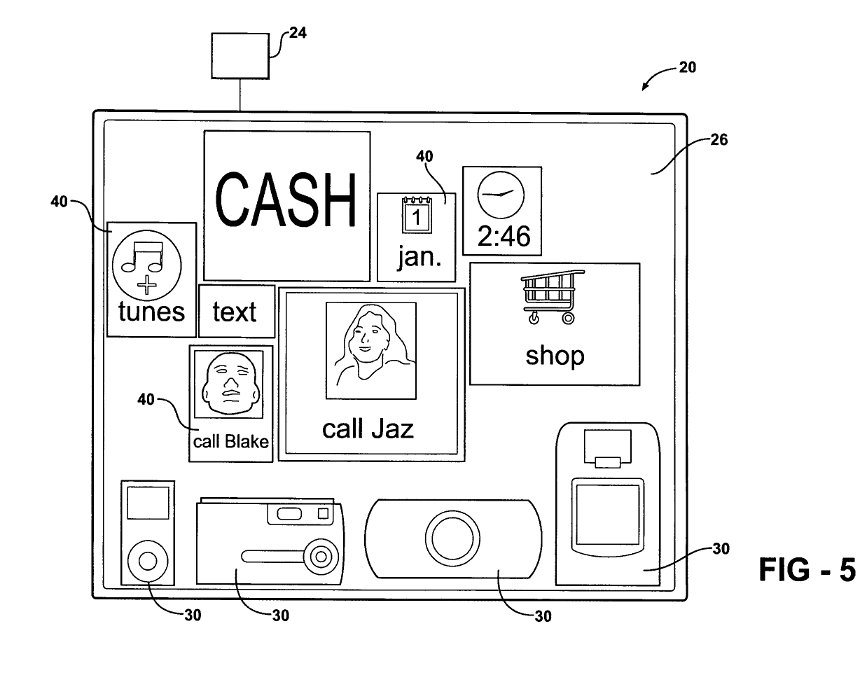

Referring to the Figures, wherein like numerals indicate corresponding parts throughout the several views, an interactive control module is generally shown at 20. Referring to FIGS. 1 through 4, the interactive control module 20 is in communication with a portable electronic device 22 for operating the portable electronic device 22.

The interactive control module 20 includes a controller 24 having a memory and a touch screen display 26. The controller 24 preferably includes a computer including the memory for storing data files and the like, and a processor for operating a software program thereon. The controller 24 and the touch screen display 26 are preferably integrally formed together as a single unit, but it should be appreciated that the controller 24 may be separate from the touch screen display 26 and communicate with the touch screen display 26 through a hard-wired connection or a wireless communication system 28, such as those described below. The touch screen display 26 preferably includes a LCD touch screen. However, it should be appreciated that the touch screen display 26 may alternatively include some other similar touch sensitive or interactive screen. The controller 24 includes voice recognition software capable of understanding spoken commands, thereby permitting a user to input commands into the control module 20 through speech. The portable electronic devices 22 may include: mobile phones; security devices, such as key fobs, I.D. cards, or I.D. tags; mobile entertainment devices; personal handheld computers; satellite radios; MP3 players; gaming devices, or some other similar portable electronic device 22.

The interactive control module 20 and the portable electronic device 22 may be connected by hard wires to communicate therebetween, but preferably communicate through a wireless communication system 28. The wireless communication system 28 may include a Bluetooth system, a Zigbee system, a RF system, or some other similar wireless communication system 28.

The subject invention discloses a method of operating the portable electronic device 22 with the interactive control module 20. The method comprises the step of detecting the presence of the portable electronic device 22. If a plurality of portable electronic devices 22 is near the interactive control module 20, the step of detecting the portable electronic device 22 is further defined as detecting the plurality of portable electronic devices 22. The interactive control module 20 manages and prioritizes the signals that are received by any of the portable electronic devices 22.

The method further comprises the step of accessing data from the portable electronic device 22. The step of accessing data from the portable electronic device 22 includes the step of wirelessly communicating between the interactive control module 20 and the portable electronic device 22. As a user having a portable electronic device 22 approaches the interactive control module 20, a two-way wireless communication network is established between the interactive control module 20 and the portable electronic device 22 by the wireless communication system 28. The two-way communication network permits data to be transferred between the interactive control module 20 and the portable electronic device 22. The step of accessing data from the portable electronic device 22 preferably includes accessing data that identifies the type and model of the portable electronic device 22. Identifying the type and model of the portable electronic device 22 permits the interactive control module 20 to display a virtual image 30 of the portable electronic device 22 on the touch screen display 26 as will be described below.

As every portable electronic device 22 looks different and includes different control features, i.e., buttons dials, switches, etc., the interactive control module 20 must know the exact make and model of the portable electronic device 22 so as to be able to display the correct virtual image 30 for each different portable electronic device 22. To that end, the interactive control module 20 must maintain data files in the memory of the controller 24 corresponding to each different portable electronic device 22. These data files for each portable electronic device 22 include a three-dimensional virtual image 30 of the portable electronic device 22 and include the location, number, and operation of all of the control features for each specific portable electronic device 22. Accordingly, once a specific portable electronic device 22 has been detected and the interactive control module 20 has addressed the data identifying the type and model of the portable electronic device 22, the interactive control module 20 may display the virtual image 30 on the touch screen display 26 as described below.

The step of accessing data from the portable electronic device 22 may also include copying files from the portable electronic device 22 to the memory of the interactive control module 20. Once the two-way wireless communication network is established, the interactive control module 20 may download or “synchronize” any updated information that is recognized as “new” content on any of the portable electronic devices 22. This new content may include new data in the form of images, screen savers, ring tones, e-mails, text messages, reminders, meeting notices, general notices, new songs or music files, movie files, videos or games, or any other information that is stored on the portable electronic devices 22 that is desirable to be accessed by the user. This downloaded information may be used by the interactive control module 20 to execute a command as will be described below.

As alluded to above, the method further comprises the step of displaying a virtual image 30 of the portable electronic device 22 on the touch screen display 26. The virtual image 30 that is displayed on the touch screen display 26 includes a look and feel that mimics that of the actual portable electronic device 22, so that the usability of the portable electronic device 22 is familiar to the user. This eliminates an additional “middle-ware” software interface that can be confusing to the user. The virtual image 30 includes the virtual control features 32 replicating the actual control features on the portable electronic device 22, thereby allowing the user to operate the buttons in a similar manner to those on the actual portable electronic device 22. It should be appreciated that if multiple portable electronic devices 22 are detected, the step of displaying a virtual image 30 of the portable electronic device 22 may further be defined as simultaneously displaying on the touch screen display 26 a virtual image 30 of each of the plurality of portable electronic devices 22 detected.

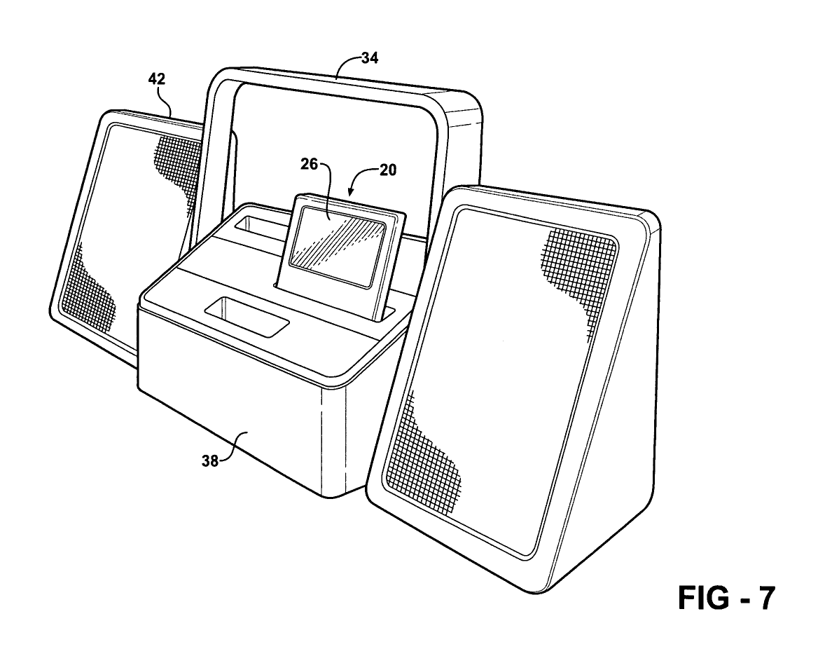

Referring to FIG. 5, the interactive control module 20 may be configured to include prioritizing software that displays the virtual representation of each of the detected portable electronic devices 22 in a menu-bar type format on a main screen of the touch screen display 26. Accordingly, the user may touch and select any virtual image 30 to gain access to the portable electronic device 22. The prioritizing software may also be configured to prioritize the virtual images 30 of the portable electronic devices 22 by color, location on the touch screen display 26 or size of the virtual image 30. The virtual images 30 may be prioritized based on any of several different criteria, such as by frequency of use, priority designation, time duration since last use, or some other criteria pre-defined by the user.

Accordingly, the method may further comprise the step of selecting a single virtual image 30 from the plurality of virtual images 30 displayed on the touch screen display 26. Once a single virtual image 30 is selected from the plurality of virtual images 30, the step of displaying the virtual image 30 of the portable electronic device 22 may further include enlarging the virtual image 30 of the portable electronic device 22 selected from the plurality of virtual images 30 displayed on the touch screen display 26. For example, assuming a plurality of virtual images 30 representing a plurality of portable electronic devices 22 are shown on a menu bar across an edge of the touch screen display 26, the user may touch one of the virtual images 30 of one of the portable electronic devices 22, thereby selecting a specific portable electronic device 22. The virtual image 30 of the specific selected portable electronic device 22 may then be centered in the touch screen display 26 and enlarged so that the user may more easily see and select the virtual control features 32.

Referring back to FIGS. 1 through 4, the method further comprises inputting a command into the voice activatable touch screen display. The step of inputting a command into the voice activatable touch screen display 26 may include touching the virtual control feature 32 to manipulate an orientation of the virtual image 30 of the portable electronic device 22 on the touch screen display 26. The user may touch the touch screen display 26 to rotate the virtual image 30 of the portable electronic device 22, or otherwise reposition the three-dimensional virtual image 30 of the portable electronic device 22 to present a virtual control feature 32 that would otherwise be hidden or obscured. For example, if the portable electronic device 22 includes a flip-phone, the flip-phone may be opened to present a hidden keypad, or the virtual image 30 may be rotated to present a button or dial located on a side of the portable electronic device 22. It should be appreciated that the three-dimensional view of the virtual image 30 of the portable electronic device 22 may be manipulated in any number of ways to present any of the virtual control features 32.

The step of inputting a command into the voice activatable touch screen display 26 may also include speaking to the controller 24. As the controller 24 includes voice recognition software, the user is able to input the command by speech, thereby eliminating the need to physically touch the touch screen display 26.

The method further comprises executing the command. The step of executing the command may include the step of transmitting the command to the portable electronic device 22. In this manner, the user touches the virtual control feature 32 on the touch screen display 26 corresponding to a specific control feature on the actual portable electronic device 22, thereby entering a specific command. The interactive control module 20 then transmits the specific command to the actual portable electronic device 22 for the portable electronic device 22 to execute. For example, a user may touch a virtual control feature 32 representing a “send” button on a mobile phone. The interactive control module 20 will then transmit the a signal to the portable electronic device 22, in this example a mobile phone, and the mobile phone will execute the “send” command to make a telephone call.

Alternatively, Referring to FIG. 6, the interactive control module 20 may include a support 34. The support 34 may include a vehicle, such as an instrument panel 36 of a vehicle, or alternatively the support 34 may include a table-top base 38. The support 34 includes an audio/visual communication system in communication with the interactive control module 20. In this manner, the step of executing the command includes utilizing the communication system of the support 34 to execute the command, i.e., the step of executing the command includes transmitting the command to the support 34 for the communication system to execute. The communication system may include a speaker system, an alarm clock, a navigation system, or some other system capable of some form of communication, whether audio communication or visual communication. The interactive control module 20 may utilize the downloaded data files from the portable electronic device 22 to execute the command on the support 34. For example, the interactive control module 20 may play an MP# file downloaded from the portable electronic device 22 on a speaker system of the support 34.

Referring back to FIG. 5, the method may further comprise the step of displaying a shortcut 40 on the touch screen display 26 of commonly inputted commands. Assuming that the user has several commonly inputted commands, the step of displaying a shortcut 40 on the touch screen display 26 is further defined as displaying a plurality of shortcuts 40 on the touch screen display 26.

The method may further comprise the step of sizing each the plurality of shortcuts 40 relative to all other of the plurality of shortcuts 40. The prioritizing software described above may also be utilized to size the shortcuts 40. The step of sizing each of the plurality of shortcuts 40 relative to all other of the plurality of shortcuts 40 may further be defined as sizing each of the plurality of shortcuts 40 relative to all other of the plurality of shortcuts 40 based on a usage rate of the plurality of shortcuts 40, and more specifically may include enlarging the shortcuts 40 having a higher usage rate relative to all other of the plurality of shortcuts 40.

The invention has been described in an illustrative manner, and it is to be understood that the terminology which has been used is intended to be in the nature of words of description rather than of limitation. As is now apparent to those skilled in the art, many modifications and variations of the present invention are possible in light of the above teachings. It is, therefore, to be understood that within the scope of the appended claims, wherein reference numerals are merely for convenience and are not to be in any way limiting, the invention may be practiced otherwise than as specifically described.

What is claimed is:

1. A method of operating a portable electronic device with an interactive control module in communication with the portable electronic device and having a touch screen display, said method comprising the steps of:
detecting the presence of the portable electronic device;
accessing data from the portable electronic device;
displaying a virtual image of the portable electronic device on the touch screen display wherein the virtual image includes a virtual control feature replicating a control feature on the portable electronic device;
inputting a command into the touch screen display; and
executing the command.

2. A method as set forth in claim 1 wherein said step of inputting a command into the touch screen display includes touching the virtual control feature to manipulate an orientation of the virtual image of the portable electronic device on the touch screen display.

3. A method as set forth in claim 1 wherein said step of executing the command includes the step of transmitting the command to the portable electronic device.

4. A method as set forth in claim 1 wherein said step of accessing data from the portable electronic device includes accessing data identifying the type and model of the portable electronic device.

5. A method as set forth in claim 1 wherein the interactive control module includes a memory and the step of accessing data from the portable electronic device includes copying files from the portable electronic device to the memory of the interactive control module.

6. A method as set forth in claim 1 wherein said step of detecting the portable electronic device is further defined as detecting a plurality of portable electronic devices.

7. A method as set forth in claim 6 wherein said step of displaying a virtual image of the portable electronic device is further defined as simultaneously displaying on the touch screen display a virtual image of each of the plurality of portable electronic devices detected.

8. A method as set forth in claim 7 further comprising the step of selecting a single virtual image from the plurality of virtual images displayed on the touch screen display.

9. A method as set forth in claim 8 wherein said step of displaying the virtual image of the portable electronic device further includes enlarging the virtual image of the portable electronic device selected from the plurality of virtual images displayed on the touch screen display.

10. A method as set forth in claim 1 wherein the interactive control module includes a support and wherein said step of executing the command includes the step of transmitting the command to the support.

11. A method as set forth in claim 10 wherein the interactive control module includes a communication system and wherein said step of executing the command includes utilizing the communication system of the support.

12. A method as set forth in claim 11 wherein the support includes a vehicle.

13. A method as set forth in claim 11 wherein the support includes a table-top base.

14. A method as set forth in claim 1 further comprising the step of displaying a shortcut on the touch screen display of commonly inputted commands.

15. A method as set forth in claim 14 wherein said step of displaying a shortcut on the touch screen display is further defined as displaying a plurality of shortcuts on the touch screen display.

16. A method as set forth in claim 15 further including the step of sizing each the plurality of shortcuts relative to all other of the plurality of shortcuts.

17. A method as set forth in claim 16 wherein said step of sizing each of the plurality of shortcuts relative to all other of the plurality of shortcuts is further defined as sizing each of the plurality of shortcuts relative to all other of the plurality of shortcuts based on a usage rate of the plurality of shortcuts.

18. A method as set forth in claim 17 wherein said step of sizing each of the plurality of shortcuts relative to all other of the plurality of shortcuts includes enlarging the shortcuts having a higher usage rate relative to all other of the plurality of shortcuts.

19. A method as set forth in claim 1 wherein the interactive control module and the portable electronic device include a wireless communication system and wherein said step of accessing data from the portable electronic device includes the step of wirelessly communicating between the interactive control module and the portable electronic device.
